(19) United States
(12) Patent Application Publication
(10) Pub. No.: US 2026/0073473 A1
(43) Pub. Date: Mar. 12, 2026

(54) SYSTEM AND METHOD FOR MAXIMIZATION OF IMAGE RESOLUTION AND MONOCULAR DEPTH ESTIMATION

(71) Applicant: GM Global Technology Operations LLC, Detroit, MI (US)

(72) Inventors: Chao-Hung Lin, Canton, MI (US); Sai Vishnu Aluru, Commerce Twp, MI (US); Alexander Lesnick, Alexandria, VA (US)

(73) Assignee: GM Global Technology Operations LLC, Detroit, MI (US)

(21) Appl. No.: 18/829,840

(22) Filed: Sep. 10, 2024

(51) Int. Cl. G06T 3/4007; G06T 3/403; G06T 7/13; G06T 7/50; H04N 25/704

(52) U.S. Cl. CPC G06T 3/4007; G06T 3/403; G06T 7/13; G06T 7/50; H04N 25/704; G06T 2207/30252

(57) ABSTRACT

A method includes receiving image data captured by a sensor system indicating an object in an object field of a vehicle, the sensor system including a plurality of micro-lenses and a pixel, each micro-lens of the plurality of micro-lenses corresponding to a sub-pixel of the pixel, each sub-pixel of the pixel having a plurality of phase-pixels. The method also includes identifying a respective phase ratio of the pixel, each of the sub-pixels of the pixel, and each phase-pixel of the plurality of phase-pixels, and identifying, based on the respective phase ratios of each of the phase-pixels, a depth of the object in the object field. The method also includes estimating an edge of the object, rearranging the sub-pixels of the pixel to generate a transformed image file of the object, and generating, for output to a viewing stack and a perception stack, the transformed image file.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to maximizing image resolution and monocular depth estimation. In particular, image systems of vehicles may be used to provide image files to users of vehicles, as well as, in the case of autonomous vehicles, feed downstream processes that rely on the data captured by the image systems to operate perception systems. As such, it is imperative to quickly and accurately detect objects in the path of the vehicle to meet approvals for safety critical autonomous systems.

In traditional phase detection, a camera lens is motorized/moves to focus on an object in the field of view of the lens. However, for safety reasons, image systems in vehicles implement fixed-focus lenses to limit downtime due to time to focus, improper focusing, and/or breaking of autofocus springs/wires. In fixed-focus lenses, the plane where the focal length of the lens matches the location of the object is in focus. However, when objects are outside the focal plane, it may be difficult to accurately approximate the distance of the object relative to the vehicle. As such, accurately mapping the distance of an object in the field of view of the vehicle, and obtaining high resolution images from the image system, are critical to safety and user trust in the autonomous vehicle.

### SUMMARY

One aspect of the disclosure provides a computer-implemented method for maximization of image resolution and monocular depth estimation that when executed on data processing hardware causes the data processing hardware to perform operations that include receiving image data captured by a sensor system of a vehicle and indicating an object in an object field of the vehicle, the sensor system including a plurality of micro-lenses and a pixel, each micro-lens of the plurality of micro-lenses corresponding to a sub-pixel of the pixel, each sub-pixel of the pixel having a plurality of phase-pixels. The operations also include identifying a respective phase ratio of the pixel, each of the sub-pixels of the pixel, and each phase-pixel of the plurality of phase-pixels. The operations also include identifying, based on the respective phase ratios of each of the phase-pixels, a depth of the object in the object field of the vehicle, and estimating an edge of the object in the object field of the vehicle. The operations further include rearranging the phase-pixels of the pixel to generate a transformed image file of the object, and generating, for output to a viewing stack and a perception stack, the transformed image file of the object.

Implementations of the disclosure may include one or more of the following optional features. In some implementations, the operations further include identifying spatial information of the plurality of the phase-pixels, receiving sensor gain ratios captured by the sensor system of the vehicle, and interpolating the respective phase ratios of the pixel, the sub-pixels, and the phase-pixels based on the spatial information from the plurality of phase-pixels and the sensor gain ratios to generate an image of the object. In some examples, estimating the edge of the object in the object field includes refining the edge of the object based on the depth of the object in the object field. In some implementations, the operations further include receiving a-priori information of a camera lens of the sensor system. In these implementations, identifying the depth of the object in the object field of the vehicle may be further based on the a-priori information of the camera lens of the sensor system.

In some examples, the operations further include receiving a color filter array from a data store in communication with the vehicle. In these examples, rearranging the phase-pixels of the pixel to generate the transformed image file of the object may be based on the received color filter array. In some implementations, the viewing stack includes image processing to render the transformed image file in a display of the vehicle. In some examples, the operations further include performing a canonical transformation on the image data and performing a de-canonical camera transformation of the transformed image file. In some implementations, the operations further include determining, based on the depth of the object in the object field of the vehicle, whether the object includes a real object in front of a windshield of the vehicle or a ghost image reflected by the windshield of the vehicle.

Another aspect of the disclosure provides a system for maximization of image resolution and monocular depth estimation that includes data processing hardware and memory hardware in communication with the data processing hardware. The memory hardware stores instructions that when executed by the data processing hardware cause the data processing hardware to perform operations that include receiving image data captured by a sensor system of a vehicle and indicating an object in an object field of the vehicle, the sensor system including a plurality of micro-lenses and a pixel, each micro-lens of the plurality of micro-lenses corresponding to a sub-pixel of the pixel, each sub-pixel of the pixel having a plurality of phase-pixels. The operations also include identifying a respective phase ratio of the pixel, each of the sub-pixels of the pixel, and each phase-pixel of the plurality of phase-pixels. The operations also include identifying, based on the respective phase ratios of each of the phase-pixels, a depth of the object in the object field of the vehicle, and estimating an edge of the object in the object field of the vehicle. The operations further include rearranging the phase-pixels of the pixel to generate a transformed image file of the object, and generating, for output to a viewing stack and a perception stack, the transformed image file of the object.

This aspect may include one or more of the following optional features. In some implementations, the operations further include identifying spatial information of the plurality of the phase-pixels, receiving sensor gain ratios captured by the sensor system of the vehicle, and interpolating the respective phase ratios of the pixel, the sub-pixels, and the phase-pixels based on the spatial information from the plurality of phase-pixels and the sensor gain ratios to generate an image of the object. In some examples, estimating the edge of the object in the object field includes refining the edge of the object based on the depth of the object in the object field. In some implementations, the operations further include receiving a-priori information of a camera lens of the sensor system. In these implementations, identifying the depth of the object in the object field of the vehicle may be further based on the a-priori information of the camera lens of the sensor system.

In some examples, the operations further include receiving a color filter array from a data store in communication with the vehicle. In these examples, rearranging the phase-pixels of the pixel to generate the transformed image file of the object may be based on the received color filter array. In some implementations, the viewing stack includes image processing to render the transformed image file in a display of the vehicle. In some examples, the operations further include performing a canonical transformation on the image data and performing a de-canonical camera transformation of the transformed image file. In some implementations, the operations further include determining, based on the depth of the object in the object field of the vehicle, whether the object includes a real object in front of a windshield of the vehicle or a ghost image reflected by the windshield of the vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for maximization of image resolution and monocular depth estimation.

FIG. 2 is a schematic view of example components of the system of FIG. 1.

FIG. 3 is a schematic view of example components of the system of FIG. 1.

FIGS. 4A-4E are example pixels of the system of FIG. 1.

FIG. 5 is an example transformed image file of the system of FIG. 1.

FIG. 6 is a flowchart of an example arrangement of operations for a method for maximization of image resolution and monocular depth estimation.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

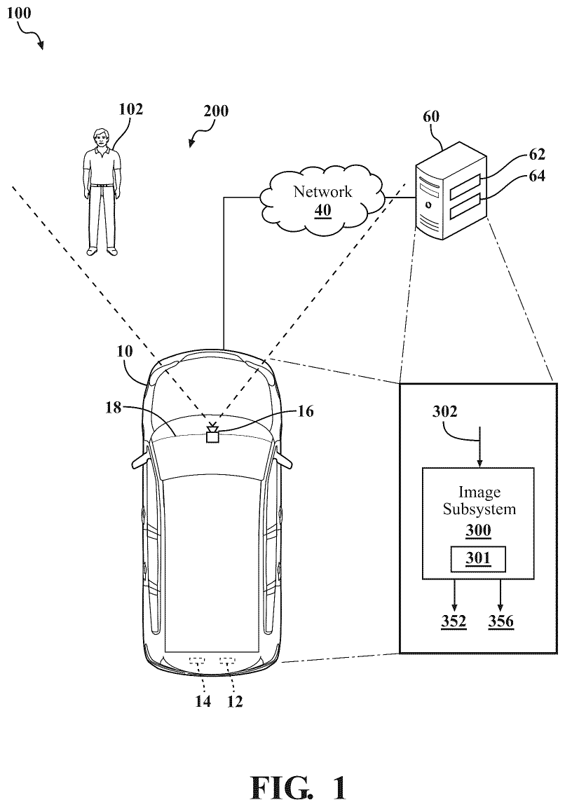

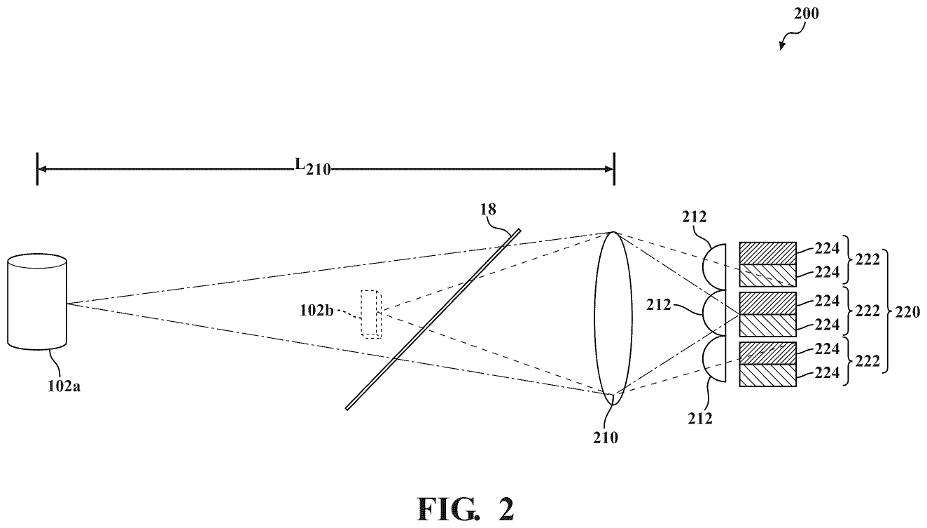

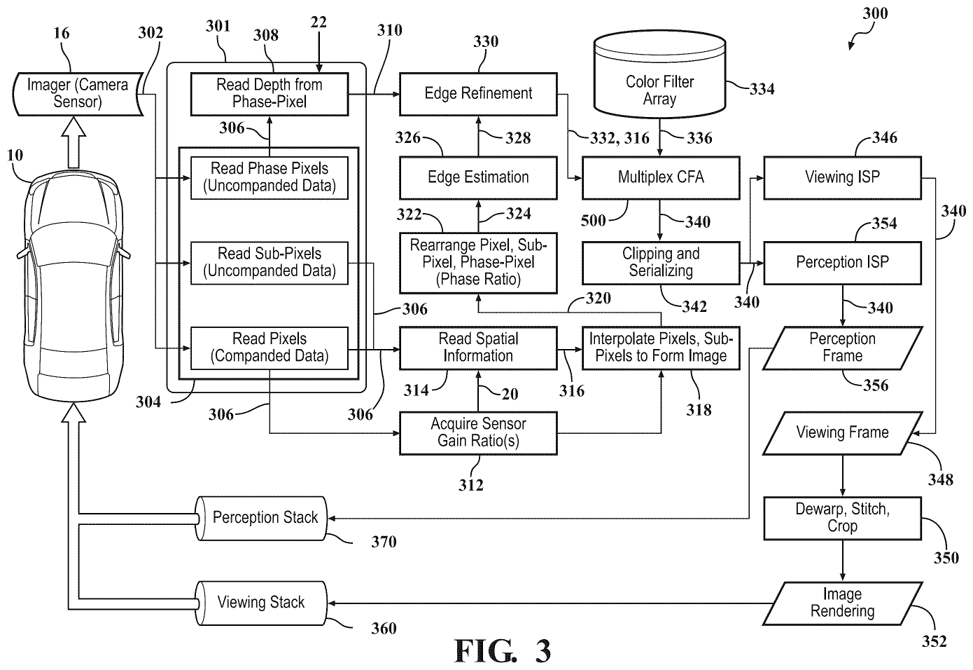

Referring to FIG. 1, in some implementations, a system 100 includes a vehicle 10 and/or a remote system 60 in communication with the vehicle 10 via a network 40. The vehicle 10 and/or the remote system 60 execute an image subsystem 300. Briefly, and as described in greater detail below, the image subsystem 300 executes a monocular depth machine learning model 301 (also referred to as a monocular depth model 301) (FIG. 3) configured to receive image data 302 from a plurality of phase-pixels 224 (FIG. 2) of a single camera 210 and generate/predict relative depth maps 310 (also referred to as depths 310) of an object 102 in an object field 200 of the vehicle 10. Thereafter, the image subsystem 300 generates, for output to a viewing stack 360 of the vehicle 10 and a perception stack 370 of the vehicle 10, a transformed image file 340 reconstructed from the plurality of phase-pixels 224 to create a higher resolution image of the object 102. Notably, the viewing stack 360 may use the transformed image file 340 to improve a user interface and/or head-up displays of the vehicle 10, while the perception stack 370 may feed downstream processes of an autonomous vehicle, thereby increasing the accuracy of safety critical systems of the vehicle 10.

In the examples shown, the image subsystem 300 is implemented within a vehicle 10. However, the image subsystem 300 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. The vehicle 10 further includes a sensor system 16 configured to capture/receive image data 302 in the object field 200 of the vehicle 10. As used herein, the object field 200 may generally refer to the areas surrounding the vehicle 10 from which the sensor system 16 is capable of capturing image data 302. The sensor system 16 may include one or more of cameras (e.g., single camera 210 (FIG. 2)), radio detection and ranging (RADAR), and light detection and ranging (LIDAR) capable of capturing image data. While the sensor system 16 shown in FIG. 1 is disposed on a front side within the vehicle 10, it should be appreciated that the sensor system 16 may include sensors located throughout the vehicle 10. For example, the sensor system 16 may provide 360-degree surround sensing of an environment of the vehicle 10.

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the image subsystem 300 is shared across the vehicle 10 and the remote system 60. As described in greater detail below with reference to FIGS. 2 and 3, the image subsystem 300 executing on the vehicle 10 and/or the remote system 60 executes a monocular depth model 301 that is configured to receive the image data 302 captured by the sensor system 16 of the vehicle 10, and predict, as output, phase ratios 306 and respective depths 310 objects 102 captured in the image data 302. The image subsystem 300 may then generate, based on the predicted phase ratios 306 and predicted depths 310 of the objects 102 generate, as output, an image rendering 352 and a perception frame 356 of the image data 302. For instance, as shown in FIG. 1, an object 102 in the object field 200 of the vehicle 10 may correspond to a pedestrian adjacent to a path of the vehicle 10. The image subsystem 300) may receive the image data 302 indicating that the object 102 (i.e., the pedestrian) is near the path of the vehicle 10, and generate (i.e., via the monocular depth model 301) an accurate depth map of the image data 302 that is used by downstream processes of the vehicle 10 to provide accurate image rendering (i.e., by the viewing stack 360) and/or more accurate safety systems (i.e., via the perception stack 370).

With reference to FIGS. 1 and 2, the sensor system 16 is shown as being directed toward a windshield 18 of the vehicle 10. As shown, the sensor system 16 may include a single camera lens 210 directed toward the windshield 18. The camera lens 210 may include a plurality of micro-lenses 212, and a pixel array 220 (also referred to as a pixel 220). The pixel 220 is generally formed from a plurality of sub-pixels 222, where each sub-pixel 222 is defined by a plurality of phase-pixels 224. As shown, each micro-lens 212 has a corresponding sub-pixel 222. By further reducing each sub-pixel 222 dimension in the pixel 220 area, the image subsystem 300 receives additional sampling points in the object field 200, resulting in higher spatial resolution and pixel density for perception applications (e.g., executed by the perception stack 370).

As shown, the object field 200 may include objects 102a, 102b that are captured as image data 302 by the sensor system 16. Specifically, the object 102a may be placed at the ideal object distance L₂₁₀ of the camera lens 210 and, as such, is in focus. Conversely, the object 102b is closer to the camera lens 210 and, as such, is out of focus. The object 102b may be a real object in front of the windshield 18 or a virtual image (also referred to as a ghost image) of an in-cabin object reflected by the windshield 18. Notably, autonomous vehicle applications used by the vehicle 10 require that the camera lens 210 be a fixed-focus lens to minimize imminent safety risks from time to focus, improper focusing, and equipment failures due to autofocus springs/wires breaking. Because the camera lens 210 is fixed, it is unable to actively refocus on the out of focus object 102b, and as such, may, without additional information, produce an inaccurate depth estimation of the object 102b relative to the camera lens 210. However, because the pixel 220 of the camera lens 210 is split into the plurality of phase-pixels 224, additional inputs (i.e., the image data 302 captured by the plurality of phase-pixels 224) are provided to the monocular depth model 301 of the image subsystem 300 to assess each phase-pixel 224's image data 302 relative to the fixed object distance L₂₁₀ of the camera lens 210. To achieve this, in addition to the image data 302 captured by each of the phase-pixels 224, the monocular depth model 301 receives a-priori information 22 of the camera lens 210. For example, the a-priori information 22 may include the object distance length L₂₁₀ of the camera lens 210 and the size of the pixel 220, which allow the monocular depth model 301 to accurately assess the absolute focal plane of each phase-pixel 224 relative to the fixed object distance L₂₁₀ of the camera lens 210. The additional depth estimation of the depth map 310 of the object 102b allows the depth model 301 to discern whether the object 102b is a real object or a ghost image.

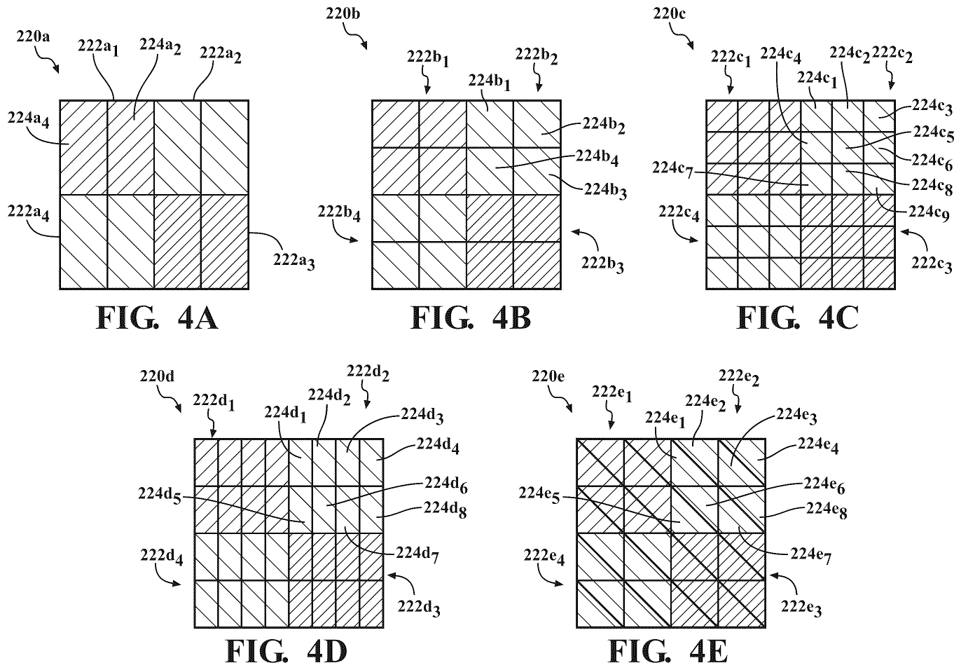

Referring briefly to FIGS. 4A-4E, the pixels 220a-220e are shown as various divisions of sub-pixels 222 and phase-pixels 224. In view of the substantial similarity in structure and function of the components associated with the pixels 220a-220e with respect to the pixel 220, like reference numerals are used hereinafter and in the drawings to identify like components while like reference numerals containing letter and/or number extensions are used to identify those components that have been modified.

As shown in FIG. 4A, the pixel 220a may be arranged as four sub-pixels 222a₁-222a₄, where each sub-pixel 222a₁-222a₄ is divided into two (2) phase-pixels 224a₁-224a₂. Here, a respective micro-lens 212 (not shown) may be positioned over each of the sub-pixels 222a₁-222a₄. Referring to FIG. 4B, the pixel 200b may be arranged as a two by two (2\hat{ }2) array including four (4) sub-pixels 222b₁-222b₄ each having four (4) phase-pixels 224b₁-224b₄. Here, each sub-pixel 222b₁-222b₄ may include a corresponding micro-lens 212 (not shown).

Referring to FIG. 4C, the pixel 220c may be arranged in a three by two (3\hat{ }2) array including four sub-pixels 222c₁-222c₄ each having nine (9) phase-pixels 224c₁-224c₉. Like the pixel 200b, each sub-pixel 222c₁-222c₄ of the pixel 200c may include a corresponding micro-lens 212 (not shown). As shown in FIG. 4D, the pixel 220d may be arranged as a two by two by two (2×2\hat{ }2) array including four (4) sub-pixels 222d₁-222d₄ each having eight (8) phase-pixels 224d₁-224d₈. Here, each sub-pixel 222d₁-222d₄ may include a corresponding micro-lens 212 (not shown). Referring to FIG. 4E, the pixel 400e may be arranged in another two by two by two (2×2\hat{ }2) array including four (4) sub-pixels 222e each having eight (8) phase-pixels 224e₁-224e₈. It should be appreciated that the foregoing pixels 220a-220e are not limiting, and the pixel 220 may be divided into any array of any number of sub-pixels 222 and/or phase-pixels 224 and corresponding micro-lenses 212.

Referring again to FIGS. 1 and 3, the image subsystem 300 executing the monocular depth model 301 is shown. In particular, the image subsystem 300 (i.e., the monocular depth model 301) may receive the image data 302 captured by the sensor system 16, the image data 302 indicating that there is an object 102 (i.e., the pedestrian) in the object field 200 of the vehicle 10. As noted above, the image data 302 may be received as separate raw images from the pixel 220, each sub-pixel 222, and each phase-pixel 224 of each sub-pixel 222. At operation 304, the monocular depth model 301 may predict/identify, based on the image data 302, the respective phase ratios 306 for the image data 302 reported/captured by each of the pixel 220, the sub-pixels 222, and the phase-pixels 224. In particular, the monocular depth model 301 may predict/identify the respective phase ratios 306 for each of the phase-pixels 224. Additionally, the monocular depth model 301 may predict the respective phase ratios 306 for each of the sub-pixels 222. Further, the monocular depth model 301 may predict the phase ratio 306 for the pixel 220 (i.e., the compounded image data 302 of all the sub-components of the pixel 220).

At operation 308, the monocular depth model 301 may receive, as input, the respective phase ratios 306 of the phase-pixels 224 and predict, based on the respective phase ratios 306 of the phase-pixels 224, the depth 310 of the object 102. For example, the monocular depth model 301 may predict/generate the depth 310 of the object 102 in the object field 200. In some implementations, the monocular depth model 301 may additionally receive, as input, a-priori information 22 on the camera lens 210 and generate the predicted depth 310 of the object 102 based on the a-priori information 22 and the phase ratios 306 of the phase-pixels 224.

At operation 312, the image subsystem 300 may acquire sensor gains 20 captured by the sensor system 16 of the vehicle 10. For instance, the sensor gains 20 may refer to the amount of gain applied on the pixel 220 to distinguish between light and dark in the object field 200. At operation 314, the image subsystem 300 receives the phase ratios 306 of the pixel 220 predicted by the monocular depth model 301 and the sensor gains 20, and generates, as output, spatial information 316 of the image data 302. Here, the spatial information 316 generally refers to an X-Y coordinate of each phase-pixel 224 in the pixel 220, where the image subsystem 300 may append a position embedding corresponding to a location of the phase-pixel 224 in the pixel 220.

At operation 318, the image subsystem 300 receives, as input, the respective phase ratios 306 of the pixel 220, the sub-pixels 222, and the phase-pixels 224, the spatial information 316, and the sensor gains 20, and generates an image 320 of the object 102. Specifically, the image subsystem 300 interpolates the respective phase ratios 306 of the pixel 220, the sub-pixels 222, and the phase-pixels 224 based on the spatial information 316 from the phase-pixels 224 and the sensor gain 20 to generate the image 320 of the object 102. In some cases, because the image subsystem 300 at operation 318 does not know where the edges (i.e., the bounds) of the object 102 are, the image subsystem 300 interpolates the phase ratios 306 from the pixel 220, sub-pixels 222, and phase-pixels 224 by aligning the phase ratios 306. In these cases, the sensor gains 20 may have distorted the prediction/inference by the monocular depth model 301 of what the pixel 220, sub-pixels 222, and phase-pixels 224 have included (i.e., via the phase ratios 306) and, as such, the predicted phase ratios 306 may be tempered using the sensor gains 20 before determining the edges of the object 102.

At operation 322, the image subsystem 300 may rearrange the image 320 to generate a rearranged image 324. Here, the image subsystem 300 may rearrange the phase-pixels 224 and/or sub-pixels 222 of the pixel 220 based on the respective phase ratios 306 of the pixel 220, sub-pixels 222, and phase-pixels 224 to form the rearranged image 324. The image subsystem 300 may receive, at operation 326, the rearranged image 324 as input and generate, as output an edge estimate 328 of the object 102 in the rearranged image 324. At operation 330, the image subsystem 300 may receive the edge estimate 328 of the rearranged image 324 and the predicted depth 310 of the object 102 based on the a-priori information 22 and the phase ratios 306 of the phase-pixels 224, and generate, as output a refined image 332. In other words, the image subsystem 300 may refine the edge estimate 328 using the predicted depth 310 of the object 102.

At operation 500, the image subsystem 300 may perform multiplex color filter analysis (CFA) on the refined image 332. For example, the image subsystem 300 may have access to a CFA data store 334 that records/stores a plurality of CFAs 336. The CFA data store 334 may be stored on any one of the memory hardware 14, 64 of FIG. 1. In some implementations, the CFA data store 334 includes a CFA lookup table of existing/pre-loaded CFAs 336 of the vehicle 10.

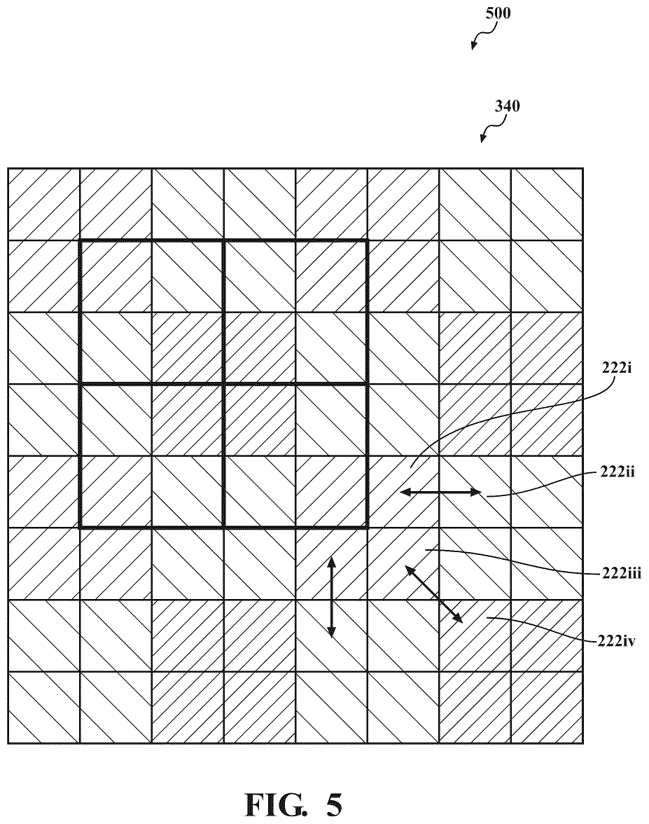

Referring briefly to FIG. 5, operation 500 may include a demosaic process to reconstruct a full color image of the refined image 332. For example, the image subsystem 300 may receive the CFA 336 and the refined image 332 including the spatial information 316, and, during the demosaic process, use the received CFA 336 to rearrange the refined image 332 by changing the pattern of the sub-pixels 22 of the pixel 220 to generate a transformed image file 340 of the object 102. For example, the CFA 336 may identify which sub-pixels 222 belong to each of Red, Blue, and Green, and transform the refined image 332 by changing the color intensity (e.g., from Red to Green) of each sub-pixel 222 in the refined image 332 based on the CFA 336. As shown in FIG. 5, the multiplex CFA at operation 500 may transform the sub-pixel 222ᵢ from Red to a Green sub-pixel 222ᵢᵢ, and the sub-pixel 222ᵢᵢᵢ from Red to a Blue sub-pixel 222ᵢᵥ. It should be appreciated that, though the colors of the example CFA 336 include Red, Green, and Blue, any color may be used in the CFA 336 so long as there are three (3) different and distinct colors.

Referring again to FIG. 3, at operation 342, the image subsystem 300 may receive, as input, the transformed image file 340 of the object 102, and clip and serialize the transformed image file 340. For example, the image subsystem 300 may identify any values of a total pixel value of the transformed image file 340 that exceed eight (8) bits, and clip any values higher than eight (8) bits from the transformed image file 340. At operation 346, the image subsystem 300 may pass the transformed image file 340 to a viewing image signal processing module used to support viewing applications of the vehicle 10. Thereafter, the image subsystem 300 may convert the transformed image file 340 to a viewing frame 348 that is, at operation 350, processed via Dewarp, Stitch, and Crop to accommodate the viewing applications of the vehicle 10, and rendered for display (e.g., on the windshield 18 of the vehicle 10 and/or a user interface of the vehicle 10) via the viewing stack 360. Similarly, the image subsystem 300 may, at operation 354, pass the transform image file 340 to a perception image signal processing module used to support perception applications of the vehicle 10. Here, the image subsystem 300 may convert the transformed image file 340 into a perception frame 356 to accommodate the perception applications of the vehicle 10 and pass the perception frame 356 to the perception stack 370 to enable autonomous functions of the vehicle 10.

In some implementations, the monocular depth model 301 of the image subsystem 300 may track the changes in the phase ratios 306 over time and, based on the rate of change of the phase ratios 306, calculate an instant velocity of the object 102 as a temporal constraint for downstream processes in the vehicle 10. Advantageously, tracking the rate of change of the phase ratios 306 enhances the stability and accuracy of the monocular depth model 301, particularly in dynamic scenarios in autonomous driving such as where objects 102 may move quickly between frames of image data 302. Moreover, the additional image data 302 captured by the phase-pixels 224 of the pixel 220 lead to the monocular depth model 301 generating higher resolution transformed image files 340.

In some examples, the monocular depth model 301 is based on a vision transformer (ViT) architecture. For instance, the monocular depth model 301 may include a pre-trained model (e.g., ViT-large, ViT-small, ViT-huge, or ViT-giant) that includes one or more attention heads configured to, at each layer of the pre-trained model, attend to each input as it relates to the previous output. In these examples, the monocular depth model 301 may be implemented such that either the ground-truth labels used to train the monocular depth model 301 or the image data 302 undergo a canonical camera transformation. Thereafter, the monocular depth model 301 generates/predicts the transformed phase ratios 306 and/or depth maps (i.e., depths 310 of objects 102), and the transformed phase ratios and/or depth aps undergo a de-canonical transformation. Here, rather than scaling the image data 302 according to the single focal length L₂₁₀ of the camera lens 210, the canonical transformation may use the focal length L₂₁₀ of the cameral lens±the number of phase ratios 306 as the scale factor for either the pixel 220, the object 102, each phase-pixel 224, each convolved feature generated by the monocular depth model 301, or each pooled feature generated by the monocular depth model 31. The maximum, median, or average of the object distance L₂₁₀ of the camera lens±the number of phase ratios 306 may be used in the canonical/de-canonical transformation. To that end, the subsequent de-canonical transformation may use the inverse of the scale factor (i.e., the focal length L₂₁₀ of the camera lens±the number of phase ratios 306), thereby distributing the enhanced accuracy to each phase-pixel 224 of the pixel 220.

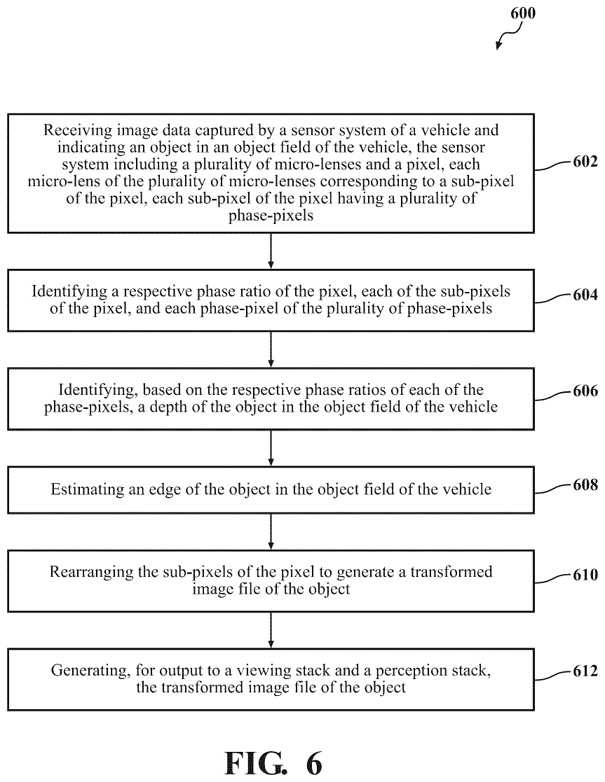

FIG. 6 includes a flowchart of an example arrangement of operations for a method 600 for maximization of image resolution and monocular depth estimation. Data processing hardware (e.g., data processing hardware 12, 62 of FIG. 1) may execute instructions stored on memory hardware (e.g., memory hardware 14, 64 of FIG. 1) to perform the example arrangement of operations for the method 600. At operation 602, the method 600 includes receiving image data 302 captured by a sensor system 16 of a vehicle 10 and indicating an object 102 in an object field 200 of the vehicle 10. The sensor system 16 includes a plurality of micro-lenses 212 and a pixel 220, each micro-lens 212 of the plurality of micro-lenses 212 corresponding to a sub-pixel 222 of the pixel 220, each sub-pixel 222 of the pixel 220 having a plurality of phase-pixels 224.

At operation 604, the method 600 includes identifying a respective phase ratio 306 of the pixel 220, each of the sub-pixels 222 of the pixel 220, and each phase-pixel 224 of the plurality of phase-pixels 224. At operation 606, the method 600 further includes identifying, based on the respective phase ratios 306, of each of the phase-pixels 224, a depth 310 of the object 102 in the object field 200 of the vehicle 10. The method 600 also includes, at operation 608, estimating an edge 328 of the object 102 in the field of the vehicle 10. At operation 610, the method 600 also includes rearranging the phase-pixels 224 of the pixel 220 to generate a transformed image file 340 of the object 102. The method 600 further includes, at operation 612, generating, for output to a viewing stack 360 and a perception stack 370, the transformed image file 340 of the object 102.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving image data captured by a sensor system of a vehicle and indicating an object in an object field of the vehicle, the sensor system comprising a plurality of micro-lenses and a pixel, each micro-lens of the plurality of micro-lenses corresponding to a sub-pixel of the pixel, each sub-pixel of the pixel having a plurality of phase-pixels;
identifying a respective phase ratio of:
the pixel;
each of the sub-pixels of the pixel; and
each phase-pixel of the plurality of phase-pixels;
identifying, based on the respective phase ratios of each of the phase-pixels, a depth of the object in the object field of the vehicle;
estimating an edge of the object in the object field of the vehicle;
rearranging the phase-pixels of the pixel to generate a transformed image file of the object; and
generating, for output to a viewing stack and a perception stack, the transformed image file of the object.

2. The method of claim 1, wherein the operations further comprise:
identifying spatial information of the plurality of the phase-pixels;
receiving sensor gain ratios captured by the sensor system of the vehicle; and
interpolating the respective phase ratios of the pixel, the sub-pixels, and the phase-pixels based on the spatial information from the plurality of phase-pixels and the sensor gain ratios to generate an image of the object.

3. The method of claim 1, wherein estimating the edge of the object in the object field comprises refining the edge of the object based on the depth of the object in the object field.

4. The method of claim 1, wherein the operations further comprise receiving a-priori information of a camera lens of the sensor system.

5. The method of claim 4, wherein identifying the depth of the object in the object field of the vehicle is further based on the a-priori information of the camera lens of the sensor system.

6. The method of claim 1, wherein the operations further comprise receiving a color filter array from a data store in communication with the vehicle.

7. The method of claim 6, wherein rearranging the phase-pixels of the pixel to generate the transformed image file of the object is based on the received color filter array.

8. The method of claim 1, wherein the viewing stack includes image processing to render the transformed image file in a display of the vehicle.

9. The method of claim 1, wherein operations further comprise:
performing a canonical transformation on the image data; and
performing a de-canonical camera transformation of the transformed image file.

10. The method of claim 1, wherein the operations further comprise determining, based on the depth of the object in the object field of the vehicle, whether the object includes a real object in front of a windshield of the vehicle or a ghost image reflected by the windshield of the vehicle.

11. A system comprising:
data processing hardware; and
memory hardware in communication with the data processing hardware, the memory hardware storing instructions that when executed on the data processing hardware cause the data processing hardware to perform operations comprising:
receiving image data captured by a sensor system of a vehicle and indicating an object in an object field of the vehicle, the sensor system comprising a plurality of micro-lenses and a pixel, each micro-lens of the plurality of micro-lenses corresponding to a sub-pixel of the pixel, each sub-pixel of the pixel having a plurality of phase-pixels;
identifying a respective phase ratio of:
the pixel;
each of the sub-pixels of the pixel; and
each phase-pixel of the plurality of phase-pixels;
identifying, based on the respective phase ratios of each of the phase-pixels, a depth of the object in the object field of the vehicle;
estimating an edge of the object in the object field of the vehicle;
rearranging the phase-pixels of the pixel to generate a transformed image file of the object; and
generating, for output to a viewing stack and a perception stack, the transformed image file of the object.

12. The system of claim 11, wherein the operations further comprise:
identifying spatial information of the plurality of the phase-pixels;
receiving sensor gain ratios captured by the sensor system of the vehicle; and
interpolating the respective phase ratios of the pixel, the sub-pixels, and the phase-pixels based on the spatial information from the plurality of phase-pixels and the sensor gain ratios to generate an image of the object.

13. The system of claim 11, wherein estimating the edge of the object in the object field comprises refining the edge of the object based on the depth of the object in the object field.

14. The system of claim 11, wherein the operations further comprise receiving a-priori information of a camera lens of the sensor system.

15. The system of claim 14, wherein identifying the depth of the object in the object field of the vehicle is further based on the a-priori information of the camera lens of the sensor system.

16. The system of claim 11, wherein the operations further comprise receiving a color filter array from a data store in communication with the vehicle.

17. The system of claim 16, wherein rearranging the phase-pixels of the pixel to generate the transformed image file of the object is based on the received color filter array.

18. The system of claim 11, wherein the viewing stack includes image processing to render the transformed image file in a display of the vehicle.

19. The system of claim 11, wherein operations further comprise:
performing a canonical transformation on the image data; and
performing a de-canonical camera transformation of the transformed image file.

20. The system of claim 11, wherein the operations further comprise determining, based on the depth of the object in the object field of the vehicle, whether the object includes a real object in front of a windshield of the vehicle or a ghost image reflected by the windshield of the vehicle.
